(19) United States
(12) Patent Application Publication
(10) Pub. No.: US 2011/0279457 A1
(43) Pub. Date: Nov. 17, 2011

(54) PLATE CHECK SUPPORTING METHOD, PLATE CHECK SUPPORTING APPARATUS, AND RECORDING MEDIUM

(75) Inventor: Zhuanshang SONG, Tokyo (JP)

(73) Assignee: FUJIFILM CORPORATION, Tokyo (JP)

(21) Appl. No.: 13/108,646

(22) Filed: May 16, 2011

(30) Foreign Application Priority Data
May 17, 2010 (JP) 2010-113334

(51) Int. Cl. G06T 1/00

(52) U.S. Cl. 345/428

(57) ABSTRACT

Sizes for blocks are determined depending on a resolution of a first image or a second image, at a time when the first image or the second image is printed. Image data areas of first image data and second image data are divided into a grid pattern of blocks. The first image data and the second image data are judged for agreement, and a check image is displayed, which includes at least one of a first check image produced by coloring the first image and a second check image produced by coloring the second image, for each of the blocks in which the first image data and the second image data are judged as not being in agreement with each other.

### CROSS-REFERENCE TO RELATED APPLICATION

This application is based upon and claims the benefit of priority from Japanese Patent Application No. 2010-113334 filed on May 17, 2010, of which the contents are incorporated herein by reference.

### BACKGROUND OF THE INVENTION

1. Field of the Invention

The present invention relates to a plate check supporting method, a plate check supporting apparatus, and a recording medium storing a program therein for displaying in a predetermined display area a check image, which shows emphasized areas where first image data and second image data generated in a platemaking process are not in agreement with each other.

2. Description of the Related Art

Recently, the fields of printing and platemaking have experienced a growing popularity of plate check supporting tools for electronically checking press plates by comparing image data as intermediate data produced when proofs are output together according to various processes, rather than by directly comparing a first proof and a revised proof according to conventional plate checking processes. Image data of the first proof and image data of the revised (or corrected) proof are compared with each other in order to automatically check if there are any correction errors, correction oversights, unwanted corrections, etc., which may be caused by mistakes made by a worker. In particular, there have been proposed various image processing techniques for emphasizing and visualizing areas where compared image data differ from each other, so as to alert a worker involved with checking press plates.

For example, Japanese Laid-Open Patent Publication No. 2010-033350 discloses an apparatus for alternately displaying a first image and a second image on a display screen. The disclosed apparatus makes it possible to perform a plate checking process on a display, instead of visually checking a proof against an original manuscript.

Japanese Laid-Open Patent Publication No. 2000-029196 discloses an apparatus for visually presenting areas where a first proof and a revised proof agree with each other as a low-density image, presenting areas where the first proof and the revised proof are different from each other as images of the first proof or the revised proof itself, and outputting a combined image, which represents the combination of the presented images.

Japanese Laid-Open Patent Publication No. 2000-029197 discloses an apparatus for displaying a differential frame image, in which areas where a first proof and a revised proof are different from each other, and in which differences therebetween are confirmed, are covered with a filled mask in a given color.

Japanese Laid-Open Patent Publication No. 2000-029198 discloses an apparatus for displaying, in windows on a display screen, partially enlarged images of a first proof and a revised proof, together with the result of a comparison between the first and revised proofs.

More specifically, according to the apparatus disclosed in Japanese Laid-Open Patent Publication No. 2010-033350, Japanese Laid-Open Patent Publication No. 2000-029196, Japanese Laid-Open Patent Publication No. 2000-029197, and Japanese Laid-Open Patent Publication No. 2000-029198, a rectangular line frame represented by solid or broken lines, which surround an area where images are different from each other, is displayed over an inspected image (or an image showing the result of a comparison between images), in order to suggest an area where the images differ from each other.

Printed mediums containing a large amount of character information, such as newspapers, magazines, etc., include characters, which are arranged regularly according to certain formats, in order for readers to be able to read the characters with ease. More specifically, such print mediums have printed image features in which the characters are arranged according to unified formats concerning writing direction, character spacing, line intervals, and font size within given columns.

In proofreading and checking edited data for use in producing press plates for printed mediums, character information is corrected for a wide variety of reasons, including not only correction of errors such as typographical errors, conversion errors, etc, but also in order to update certain information with latest information, or to replace articles, etc. In other words, areas where such edited data need to be corrected tend to occur randomly at a plurality of positions in a plate checking process.

If the apparatus disclosed in Japanese Laid-Open Patent Publication No. 2010-033350, Japanese Laid-Open Patent Publication No. 2000-029196, Japanese Laid-Open Patent Publication No. 2000-029197, and Japanese Laid-Open Patent Publication No. 2000-029198 are applied to check edited data containing a large amount of regularly arranged character information, then the following problems are likely to arise.

If a plurality of areas where compared images are different from each other are present in the image data in close proximity to each other, then since a plurality of frame lines are displayed in an overlapping manner, it is awkward to recognize differences in character shapes from the areas surrounded by the respective frames, and to specify details of corrections to be made to the edited data. In particular, if the resolution of edited data is low, then when one or more frame lines are generated over a plurality of characters, it is not easy to specify details of corrections to be made to the edited data. As a result, the efficiency of the plate checking process on the edited data cannot be increased.

### SUMMARY OF THE INVENTION

It is an object of the present invention to provide a plate check supporting method, a plate check supporting apparatus, and a recording medium storing a program therein, in which it is possible to easily identify areas where compared image data are different from each other, thereby increasing efficiency of the plate checking process on edited data that contains a large amount of regularly arranged character information.

According to the present invention, there is provided a plate check supporting method for displaying, in a predetermined display area, a check image showing emphasized areas in which first image data and second image data generated in a platemaking process are not in agreement with each other.

The plate check supporting method comprises a resolution acquiring step of acquiring a resolution for a first image represented by the first image data or a second image represented by the second image data when the first image or the second image is printed, a block size determining step of determining sizes for blocks into which image data areas of the first image data and the second image data are divided, depending on the acquired resolution, an area dividing step of dividing the image data areas into a grid pattern of blocks having the determined sizes, an agreement judging step of judging the first image data and the second image data for agreement with respect to each of the blocks, and a first display step of displaying a check image, which includes at least one of a first check image produced by coloring the first image and a second check image produced by coloring the second image, for each of the blocks in which the first image data and the second image data are judged as not being in agreement with each other.

As described above, the plate check supporting method includes a resolution acquiring step of acquiring a resolution for a first image or a second image when the first image or the second image is printed, a block size determining step of determining sizes for blocks depending on the acquired resolution, and an area dividing step of dividing the image data areas into a grid pattern of blocks having the determined sizes. Therefore, it is possible to establish appropriate sizes of actual images in which data thereof is assessed for agreement. The plate check supporting method also includes a first display step of displaying a check image, which includes at least one of a first check image produced by coloring the first image and a second check image produced by coloring the second image, for each of the blocks in which the first image data and the second image data are judged as not being in agreement with each other. Consequently, areas where compared character data are different from each other are appropriately emphasized along an array of characters. Even if edited data are checked, which contain a large amount of regularly arranged character information, areas where the compared data differ from each other can easily be identified, so that efficiency of the plate checking process can be increased.

In the first display step, the first check image, which is colored in a prescribed color, and the second check image, which is colored in a color different from the prescribed color, are preferably displayed alternately at a prescribed time interval in a first display area within the predetermined display area.

The plate check supporting method preferably further includes a second display step of displaying either one of the first image and the second image in a second display area, which does not overlap with the first display area, within the predetermined display area.

The plate check supporting method preferably further includes a scroll display step of displaying the images displayed in the first display area and the second display area in a scrollable and ganged fashion, in response to an input action from the user.

The plate check supporting method preferably further includes a scaled display step of displaying the images displayed in the first display area and the second display area at a scaled ratio in a ganged fashion, in response to an input action from the user.

The plate check supporting method preferably further includes a comment information assigning step of assigning comment information to the image displayed in the second display area.

The plate check supporting method preferably further includes a block position determining step of determining a positional relationship between the blocks, which are arranged cyclically, and the image data areas.

In the block size determining step, if the first image data or the second image data have image data representing characters, the sizes are preferably determined for the blocks depending on size information of the characters and the resolution.

In the block position determining step, if the first image data or the second image data have image data representing characters, the positional relationship is preferably determined depending on intervals between the characters and a direction of the characters.

The plate check supporting method preferably further includes a check image data generating step of generating check image data depending on the check image, by performing a color conversion process for adding a prescribed value to or subtracting a prescribed value from all of the pixels in the blocks, for which the first image data and the second image data are judged as not being in agreement with each other.

In the block size determining step, the sizes are preferably determined for the blocks so as to print the blocks at the same size irrespective of the resolution.

According to the present invention, there is also provided a plate check supporting apparatus for displaying, in a predetermined display area, a check image showing emphasized areas where first image data and second image data generated in a platemaking process are not in agreement with each other, comprising a resolution acquirer for acquiring a resolution for a first image represented by the first image data or a second image represented by the second image data when the first image or the second image is printed, an area divider for determining sizes for blocks into which image data areas of the first image data and the second image data are divided, depending on the resolution acquired by the resolution acquirer, and dividing the image data areas into a grid pattern of blocks having the determined sizes, an image agreement determiner for judging the first image data and the second image data for agreement with respect to each of the blocks produced by the area divider, and a display unit for displaying a check image, which includes at least one of a first check image produced by coloring the first image and a second check image produced by coloring the second image, for each of the blocks in which the first image data and the second image data are judged as not being in agreement with each other by the image agreement determiner.

According to the present invention, there is further provided a recording medium storing therein a program for displaying, in a predetermined display area, a check image showing emphasized areas where first image data and second image data generated in a platemaking process are not in agreement with each other, the program enabling a computer to function as a resolution acquirer for acquiring a resolution for a first image represented by the first image data or a second image represented by the second image data when the first image or the second image is printed, an area divider for determining sizes for blocks into which image data areas of the first image data and the second image data are divided, depending on the resolution acquired by the resolution acquirer, and dividing the image data areas into a grid pattern of blocks having the determined sizes, an image agreement determiner for judging the first image data and the second image data for agreement with respect to each of the blocks produced by the area divider, and a check image data generator for generating check image data depending on a check image, which includes at least one of a first check image produced by coloring the first image and a second check image produced by coloring the second image, for each of the blocks in which the first image data and the second image data are judged as not being in agreement with each other by the image agreement determiner.

With the plate check supporting method, the plate check supporting apparatus, and the recording medium according to the present invention, a resolution is acquired for a first image, which is represented by first image data, or a second image, which is represented by second image data, when the first image or the second image is printed. Further, sizes are determined for blocks into which image data areas of the first image data and the second image data are divided, depending on the acquired resolution. The image data areas are divided into a grid pattern of blocks having the determined sizes, and with respect to each of the blocks, the first image data and the second image data are judged for agreement with each other. A check image is displayed, which includes at least one of a first check image produced by coloring the first image and a second check image produced by coloring the second image, for each of the blocks in which the first image data and the second image data are judged as not being in agreement with each other. Therefore, it is possible to establish appropriate sizes of actual images for which data thereof are determined as being in agreement or not. Also, areas where compared character data are different from each other are appropriately emphasized along an array of characters. Even if edited data containing a large amount of regularly arranged character information are checked, areas where the compared data differ from each other can easily be identified, so that efficiency of the plate checking process can be increased.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of a printing system incorporating therein an image processing apparatus, which serves as a plate check supporting apparatus according to an embodiment of the present invention;

FIG. 2 is a functional block diagram of the image processing apparatus shown in FIG. 1;

FIG. 3 is a flowchart of a printing process, which is carried out by the printing system shown in FIG. 1;

FIG. 4 is a view showing an initial setting screen for an image display;

FIG. 5 is a flowchart of a sequence for generating first and second check image data;

FIG. 6 is a schematic diagram showing a positional relationship between an image data area and blocks;

FIG. 7 is a view showing a plate check support display screen in a first configuration;

FIG. 8 is a view showing a plate check support display screen in a second configuration;

FIG. 9 is a view showing a plate check support display screen in a third configuration;

FIG. 10 is a view showing a plate check support display screen in a fourth configuration;

FIGS. 11A and 11B are schematic diagrams showing a positional relationship between an image data area and blocks;

FIGS. 12A through 12C are partially enlarged views showing examples of colored blocks; and

FIG. 13 is a view showing a plate check support display screen in a fifth configuration.

### DESCRIPTION OF THE PREFERRED EMBODIMENTS

Like or corresponding parts are denoted by like or corresponding reference characters throughout the views.

A plate check supporting method according to an embodiment of the present invention, in relation to a plate check supporting apparatus and a printing system in which the plate check supporting method is carried out, will be described in detail below with reference to the accompanying drawings.

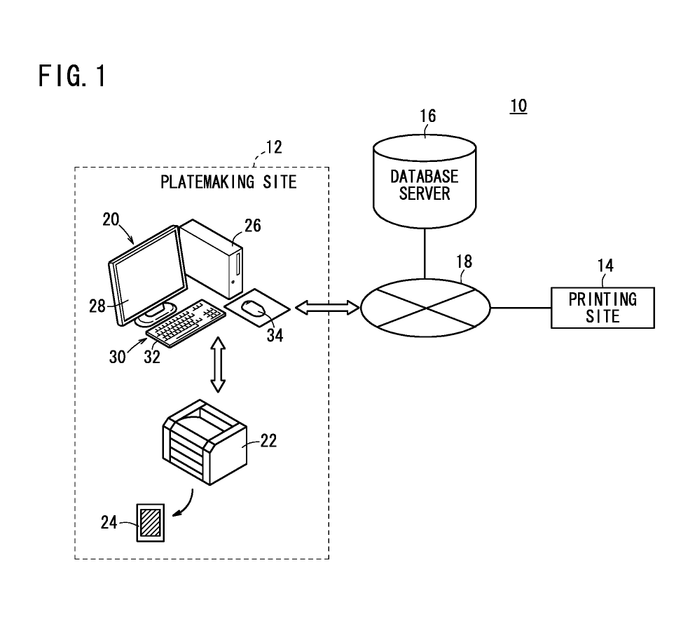

FIG. 1 is a schematic view of a printing system 10 incorporating therein an image processing apparatus 20, which serves as a plate check supporting apparatus according to an embodiment of the present invention.

As shown in FIG. 1, the printing system 10 basically comprises a platemaking site 12, a printing site 14, a database server 16, and a LAN 18. The platemaking site 12 includes an image processing apparatus (plate check supporting apparatus) 20 and a proof press 22.

The image processing apparatus 20 generates platemaking data in a page description language (hereinafter referred to as “PDL”) or edited data in an editing process, e.g., PDL-format data in color channels of four colors (CMYK) or three colors (RGB). In each page of the platemaking data or edited data, the layout of color images representing characters, figures, patterns, photographs, etc., can freely be edited.

PDL refers to a language, which is descriptive of image information including document information, position information, color information (including density information), etc., of characters, figures, etc., in a “page” that serves as an output unit for printing, displaying, or the like. Known types of PDL include PDF (Portable Document Format according to ISO32000-1:2008), PostScript (registered trademark of Adobe Systems), and XPS (XML Paper Specification).

The image processing apparatus 20 has various functions to perform desired image processing processes including, for example, a color conversion process, a layout process, etc., on PDL-format edited data, in order to convert the PDL-format edited data into raster-format image data, e.g., bitmap or TIFF image data (hereinafter also referred to as raster image data), as well as to convert the raster-format image data into printing control signals that match the printing process of the proof press 22, and send the printing control signals to the proof press 22.

The image processing apparatus 20 compares image data that is currently being edited, and displays check images for emphasizing and visualizing areas where the compared image data differ from each other, in order to support the operator (user) during plate checking. (Displaying of such check images will also be referred to as “plate check support display”).

The image processing apparatus 20 includes a main unit 26, a display unit 28, and an input unit 30 including a keyboard 32 and a mouse 34. The mouse 34, which functions as a pointing device, may be replaced with a track pad or a track ball.

The proof press 22 is an output device for producing a proof print 24, which is proofread for edited data (imposed data). The proof press 22 may comprise a DDCP (Direct Digital Color Proofer), which is equivalent in performance to an offset press, an ink jet color proofer, a low-resolution color laser printer (electrophotographic printer), an ink jet printer, or the like.

The database server 16 stores and manages platemaking data files (TIFF files and PDF files), which have been proofread, and job tickets, for example, JDF (Job Definition Format) files.

The LAN 18 is a network constructed according to communication standards such as Ethernet (registered trademark) or the like. The platemaking site 12, the printing site 14, and the database server 16 are connected to each other via the LAN 18. The platemaking site 12 and the printing site 14 are located in different working areas, so that a platemaking process, which takes place in the platemaking site 12, and a printing process, which takes place in the printing site 14, are related to each other through the LAN 18.

The printing site 14 includes an image processing device for performing a desired image processing process on a platemaking data file acquired from the database server 16, a platesetter for creating printing plates, and an offset press, a digital printing press, or the like, for printing desired color images on various mediums.

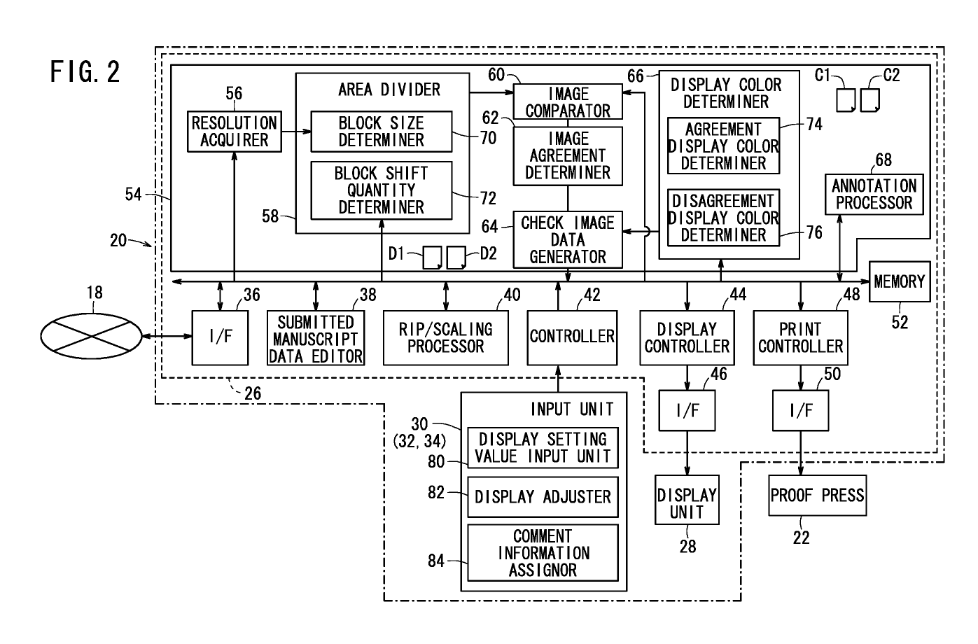

FIG. 2 is a functional block diagram of the image processing apparatus 20 shown in FIG. 1.

As shown in FIG. 2, the main unit 26 includes an I/F 36, a submitted manuscript data editor 38, a RIP and scaling processor (raster imaging processor) 40, a controller 42, a display controller 44, an I/F 46, a print controller 48, an I/F 50, a memory (recording medium) 52, and a plate check processor 54.

The submitted manuscript data editor 38 can edit one or more submitted manuscript data files in order to generate pages of edited data. For example, the submitted manuscript data editor 38 performs various editing processes, including a layout process, a color adjusting process, an imposing process, etc., for example. The submitted manuscript data editor 38 can also correct edited data based on the results of a proof print.

The RIP and scaling processor 40 expands PDL-format edited data file into raster image data. The RIP and scaling processor 40 can scale (enlarge or reduce) raster image data in accordance with a desired image magnification ratio.

The controller 42 may comprise a processor such as a CPU. The controller 42 controls various parts of the main unit 26, including the RIP and scaling processor 40, the display controller 44, the plate check processor 54, etc.

The display controller 44 comprises a control circuit for controlling the display unit 28 under the supervision of the controller 42. More specifically, when the display controller 44 outputs a display control signal to the display unit 28 via the I/F 46, the display unit 28 is controlled to display images.

The print controller 48 comprises a control circuit for controlling the proof press 22 under the supervision of the controller 42. More specifically, when the print controller 48 outputs a print control signal to the proof press 22 via the I/F 50, the proof press 22 is controlled to print a proof print 24.

The memory 52 stores programs and data, which are required for the controller 42 to control various parts, e.g., data required for the plate check processor 54 to perform various processes, and also stores edited data files. The memory 52 may comprise a recording medium such as a nonvolatile memory, a hard disk, or the like.

The plate check processor 54 includes a resolution acquirer 56, an area divider 58, an image comparator 60, an image agreement determiner 62, a check image data generator 64, a display color determiner 66, and an annotation processor 68.

The resolution acquirer 56 acquires a resolution for an image, which is represented by edited data at a time when the image is printed. The resolution acquirer 56 can automatically acquire the resolution from tag information, which is ancillary to edited data, for example.

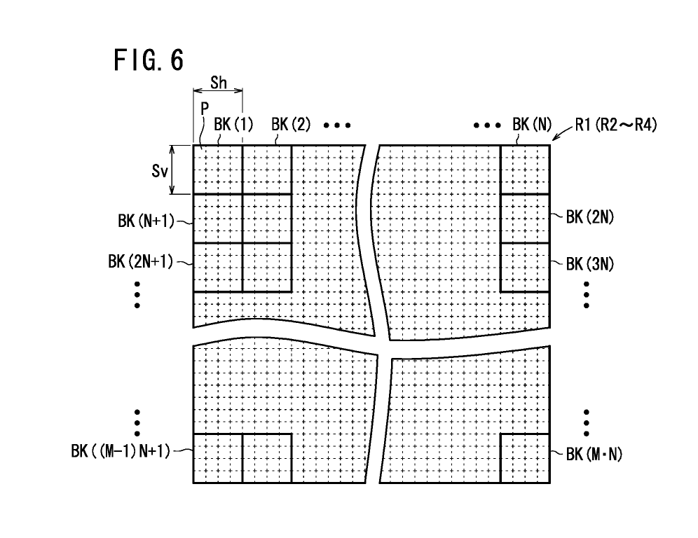

The area divider 58 divides each of image data areas R1, R2 (see FIG. 6), which are to be inspected and compared, into blocks BK. The area divider 58 includes a block size determiner 70 for determining sizes Sh, Sv (see FIG. 6) of the blocks BK depending on the resolution. The area divider 58 also includes a block shift quantity determiner 72 for determining a shift quantity, which is representative of a relative positional relationship between the blocks BK in the image data areas R1, R2.

The image comparator 60 compares and evaluates two items of raster image data (e.g., first image data C1 and second image data C2, which are generated in the platemaking process) with respect to each block BK. The image agreement determiner 62 determines whether or not agreement exists between the first image data C1 and the second image data C2, based on the result of the comparison with respect to each block BK.

The check image data generator 64 generates check image data depending on a check image, in which areas are emphasized where the first image data C1 and the second image data C2 are not in agreement with each other. The check image data include at least one of first check image data D1 and second check image data D2, to be described later.

The display color determiner 66 determines each of colors to be applied to the images that are displayed. The display color determiner 66 includes an agreement display color determiner 74 for determining a display color, with respect to blocks BK for which the compared data are judged as being in agreement with each other. The display color determiner 66 also includes a disagreement display color determiner 76 for determining a display color, with respect to blocks BK for which the compared data are judged as not being in agreement with each other.

The input unit 30 functions as a display setting value input unit 80 for entering various setting values for the plate check support display, a display adjuster 82 for adjusting a range and size at which check images are displayed, etc., and a comment information assignor 84 for assigning comment information to a displayed image.

As described later, the annotation processor 68 and the comment information assignor 84 perform an annotation function in order to assign various items of comment information to the displayed images.

The image processing apparatus 20 according to the present embodiment basically is constructed as described above. The aforementioned image processing functions of the image processing apparatus 20 are realized by application software (programs), which are stored in the memory 52 and run on under the control of basic operating software (operating system).

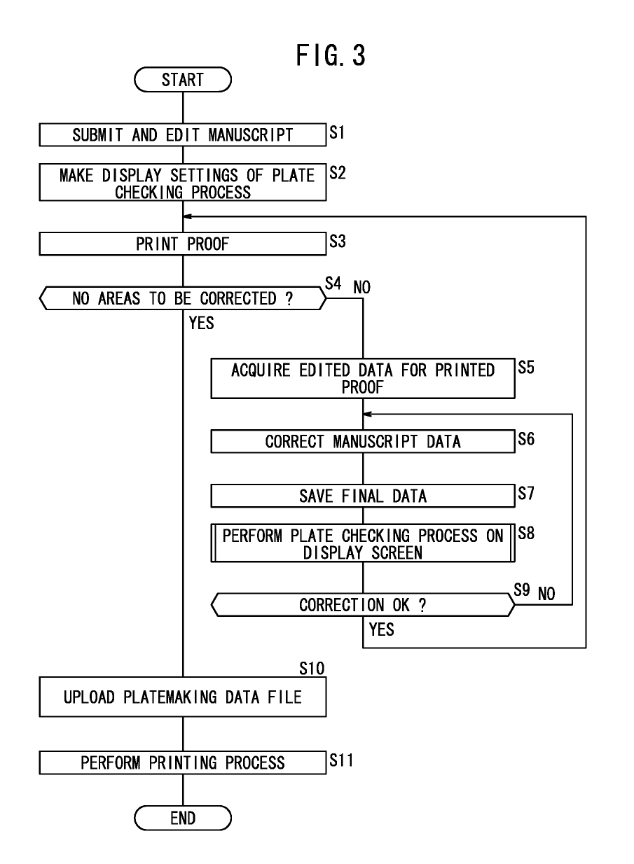

The printing system 10 according to the present embodiment is basically constructed as described above. Operations of the printing system 10 will be described below with reference to the flowchart shown in FIG. 3 and the functional block diagram shown in FIG. 2.

The platemaking process in the platemaking site 12 (see FIG. 1) comprises steps S1 through S10. In connection with the present embodiment, a plate checking process will primarily be described below.

The operator (user) submits manuscript data, which is to be edited (step S1). As shown in FIG. 2, in response to an instruction from the client to submit a manuscript, a terminal device (not shown) supplies a desired manuscript data file to the image processing apparatus 20 via the LAN 18. The image processing apparatus 20 acquires the submitted manuscript data file via the I/F 36, and stores the submitted manuscript data file in the memory 52.

Depending on the editing process performed by the operator, the submitted manuscript data editor 38 performs various editing processes, such as a layout process, a color adjusting process, etc., on one or more submitted manuscript data files, in order to generate pages of edited data. Then, the submitted manuscript data editor 38 imposes pages according to a binding process and a page folding process, which have been designated. Thereafter, in response to a notice that generation of the edited data is finished, the memory 52 stores the edited data, which was generated by the submitted manuscript data editor 38, as an edited data file.

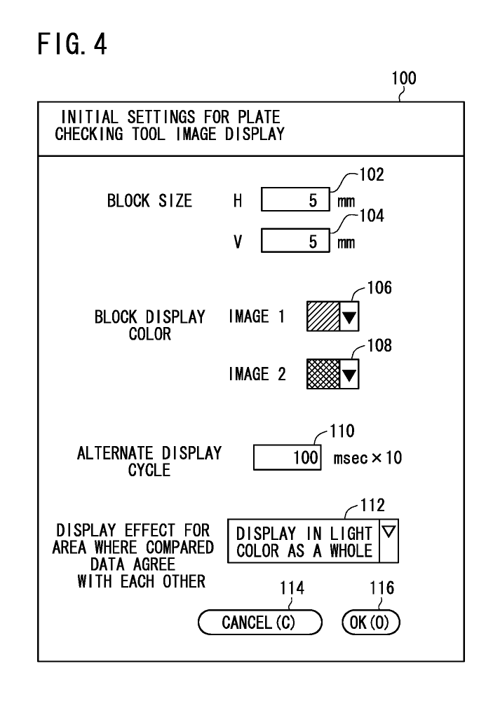

Then, the operator makes display settings of a plate checking process, depending on the type of edited data, preferences of the operator, etc. (step S2). In response to a request from the operator to make display settings, the display controller 44 displays the setting screen 100 shown in FIG. 4 on the display unit 28.

The setting screen 100 includes two text boxes 102, 104, two color selection menus 106, 108, a text box 110, a pull-down menu 112, and buttons 114, 116, which are labeled “CANCEL (C)” and “OK (O)”, respectively.

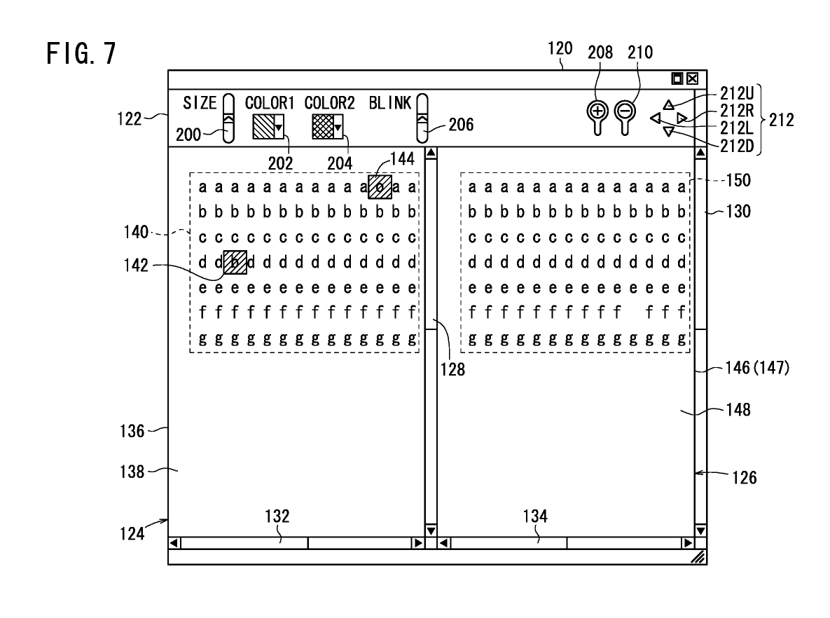

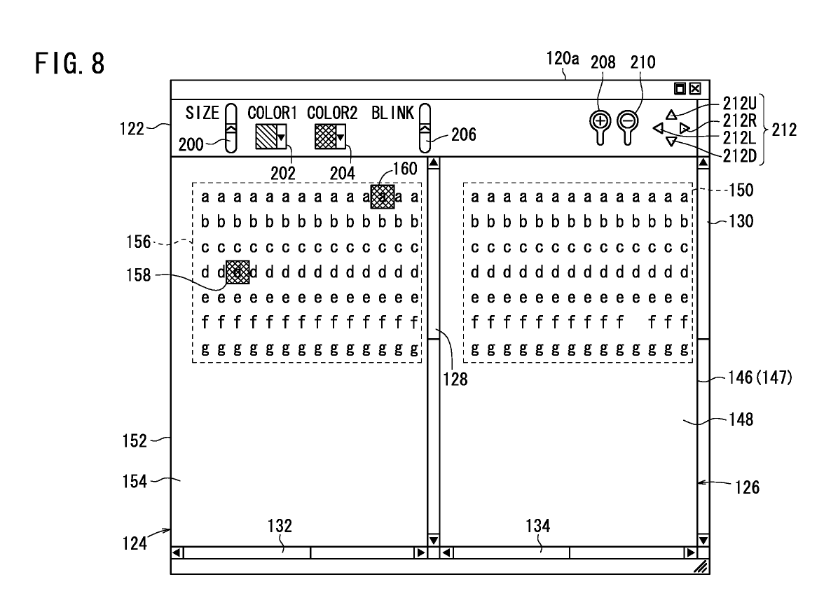

When the button 116 is clicked by the mouse 34, the display setting value input unit 80 enters initial setting data for the plate check support display to the main unit 26. Information entered in the text boxes 102, 104 represents sizes Sh, Sv (see FIG. 6) of the blocks BK, to be described later. Information entered in the color selection menu 106 represents a color of the blocks BK in the image data area R1 (first colored areas 142, 144 as shown in FIG. 7). Information entered in the color selection menu 108 represents a color of the blocks BK in the image data area R2 (second colored areas 158, 160 as shown in FIG. 8). Information entered in the text box 110 represents a time interval (switching cycle) during which images are alternately displayed, as described later. Information entered in the pull-down menu 112 represents a type of a display effect to be applied to areas where the compared image data are in agreement with each other.

In FIG. 3, the operator produces a proof print based on the edited data (step S3).

In response to an instruction from the operator to produce a proof print, the RIP and scaling processor 40 shown in FIG. 2 expands the edited data (PDL format), which was acquired from the memory 52, into raster image data. The print controller 48 then converts the raster image data into print control signals. The proof press 22 acquires the print control signals via the I/F 50, and prints a color image on a medium (not shown) based on the print control signals, thereby producing a proof print 24. At this time, the proof press 22 may adjust colors of the proof print 24 according to the known color matching technique, in order to match colors that are printed at the printing site 14.

Then, the operator visually checks the proof print 24 to confirm whether the proof print 24 contains any areas that require correction (step S4). If the operator finds an area in need of correction, then the operator makes a note of the area and correction details on the proof print 24. The operator acquires the edited data when the proof print is printed (step S5). If necessary, the operator corrects the edited data (step S6). The submitted manuscript data editor 38 changes the contents of the edited data file according to the change instruction from the operator. The operator may confirm whether or not all areas requiring correction have been corrected properly by referring to the proof print 24 with the notes made thereon.

Then, the operator judges that all corrections have been completed and saves the final data (step S7). The memory 52 stores the final data as a new edited data file.

Then, the operator performs a plate checking process on the display screen (step S8).

More specifically, according to the present embodiment, the operator compares first image data C1, which is expanded into raster-format data and representative of the edited data at the time that the proof print is printed (see step S5), and second image data C2, which is representative of the corrected final data (see step S7) expanded into raster-format data. The image processing apparatus 20 then displays check images showing emphasized areas where the first image data C1 and the second image data C2 are not in agreement with each other. The check images include a first check image obtained by coloring a first image (an image represented by the first image data C1) and a second check image obtained by coloring a second image (an image represented by the second image data C2). In order to realize such functions, the image processing apparatus 20 operates in the following manner.

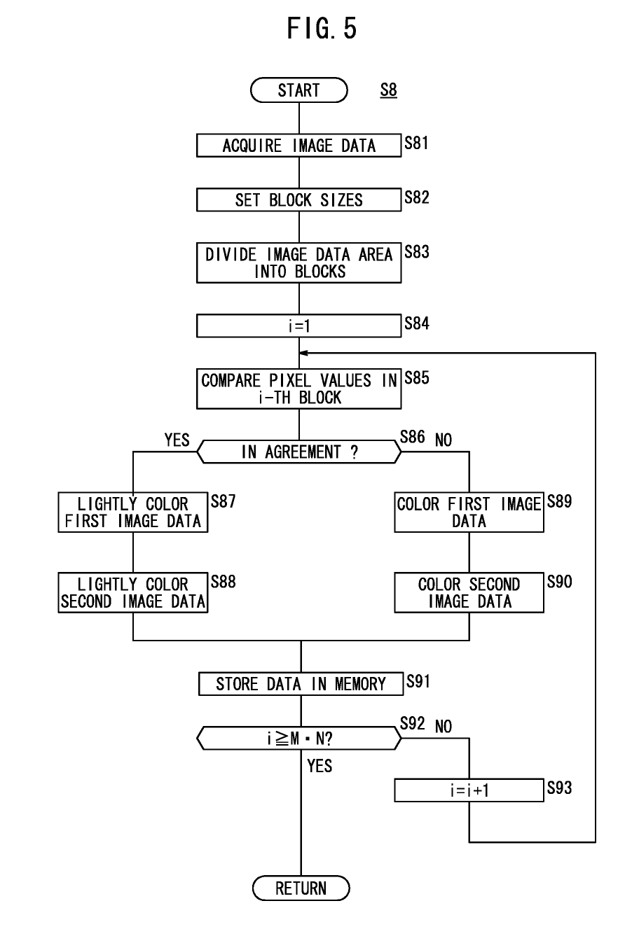

The plate check processor 54 shown in FIG. 2 generates check image data for the plate check support display. A process of generating first check data D1 for displaying the first check image, and second check data D2 for displaying the second check image will be described in detail below with reference to the flowchart shown in FIG. 5.

First, image data to be compared are acquired (step S81). The RIP and scaling processor 40 expands the edited data (PDL format), which already has been stored in the memory 52, into raster-format data, to thereby produce first image data C1 and second image data C2.

Then, sizes Sh, Sv of blocks BK are determined (step S82). The blocks BK serve as unit areas into which the image data areas R1, R2 are divided.

Prior to determining sizes Sh, Sv of the blocks BK, the resolution acquirer 56 acquires a printing resolution for a first image or a second image. At this time, the resolution acquirer 56 may refer to tag information contained within the edited data file, or output information related to the edited data file.

The block size determiner 70 determines sizes Sh, Sv of the blocks BK based on the resolution acquired from the resolution acquirer 56. The size Sh represents the number of pixels in a horizontal direction, whereas the size Sv represents the number of pixels in a vertical direction. If a block has a size of 5 mm, then the corresponding number of pixels is about 60 for a resolution of 300 dpi (dots per inch), and about 120 for a resolution of 600 dpi. Since the printed size of each block BK is the same irrespective of resolution, the printed size can easily be associated with an image area of actual dimensions, thereby resulting in increased inspection efficiency.

The sizes Sh, Sv may be of the same value or different values. In other words, each block BK may have either a square shape or a rectangular shape.

Then, each of the image data areas R1, R2 is divided into a plurality of blocks BK (step S83).

As shown in FIG. 6, the image data area R1 of the first image data C1 is associated with positions of a plurality of pixels P, which are arranged in the form of a two-dimensional grid. Similarly, the image data area R2 of the second image data C2 is associated with positions of a plurality of pixels P, which are arranged in the form of a two-dimensional grid. If there are M blocks BK in a vertical direction and N blocks BK in a horizontal direction, then each of the image data areas R1, R2 is divided into M·N blocks BK. In order to identify the blocks BK, the blocks BK are designated respectively as blocks BK(1) through BK(M·N).

In FIG. 6, each of the sizes Sh, Sv is represented by four pixels. An area defined by each block BK contains sixteen pixels (4×4 pixels). The area divider 58 divides each of the image data areas R1, R2 into a plurality of blocks BK (step S83).

The controller 42 allocates memory areas (image data areas R3, R3) from the memory 52 for storing an amount of data corresponding to the image data areas R1, R2.

In FIG. 5, a counter i is initialized (step S83), where i indicates the suffix of a block BK(i) and can be any integral value in the range from 1 to M·N.

Then, pixel values in the i-th block BK(i) are compared (step S85). If the first image data C1 have a plurality of color channels, then the pixel values are compared for each of the color channels. For example, if the first image data C1 comprise RGB data, then the pixel values are compared for each of the colors R, G, B.

Then, the data are judged to assess agreement therebetween with respect to the i-th block BK(i) (step S86). The data may be judged as agreeing with each other when all of the pixel values in the i-th block BK(i) agree with each other, or when a certain number of pixel values in the i-th block BK(i) agree with each other. Furthermore, the data may be judged as agreeing with each other not only when all of the pixel values in the i-th block BK(i) agree with each other, but also when the difference between pixel values falls within an allowable range.

If the data are judged as being in agreement with each other, then the first image data C1 are lightly colored (step S87), and the second image data C2 are lightly colored (step S88). The disagreement display color determiner 76 determines, in advance, a coloring process according to the process selected on the pull-down menu 112 (see FIG. 4).

The check image data generator 64 performs a color conversion process on the first image data C1 and the second image data C2, according to the coloring process acquired from the disagreement display color determiner 76.

The color conversion process may be carried out by any algorithm. For example, the check image data generator 64 may perform a color conversion process to add a certain value to or to subtract a certain value equally from all of the pixel values in the i-th block BK(i), to thereby lightly color the first image data C1 and the second image data C2. Such a color conversion process makes it possible to speed up the operation sequence.

The pull-down menu 112 (see FIG. 4) may have a selectable item, which is labeled “DISPLAY COLOR AS IS”, and which is selected when no color conversion process is to be performed.

If the data are judged as being in disagreement with each other, then the first image data C1 are colored with a first color (step S89), and the second image data C2 are colored with a second color (step S90). The agreement display color determiner 74 determines, in advance, the color selected on the color selection menu 106 (see FIG. 4) as the first color, and determines, in advance, the color selected on the color selection menu 108 (see FIG. 4) as the second color.

The check image data generator 64 performs a color conversion process on the first image data C1, so as to color the first image data C1 with the first color acquired from the agreement display color determiner 74. The check image data generator 64 also performs a color conversion process on the second image data C2, so as to color the second image data C2 with the second color acquired from the agreement display color determiner 74.

The color conversion process may be carried out by any algorithm. For example, the check image data generator 64 may perform a color conversion process to add a certain value to or to subtract a certain value equally from all of the pixel values in the i-th block BK(i), to thereby color the first image data C1 and the second image data C2. Such a color conversion process makes it possible to speed up the operation sequence.

The color difference between the first color and the second color should preferably be large in order to emphasize the difference between the first and second colors. For example, the first color may be green, and the second color may be red. The first color and the second color may be high-saturation colors for better visibility. Alternatively, the first color and the second color may be changed depending on the content (e.g., background color) of the edited data.

As shown in FIG. 5, the image data processed in steps S87 through S90 are stored in the memory 52 (step S91). More specifically, the check image data generator 64 stores the color-converted first image data in a memory area within the image data area R3 corresponding to the i-th block BK(i), and stores the color-converted second image data in a memory area within the image data area R4 corresponding to the i-th block BK(i).

Then, the counter i and the total number M·N of the blocks BK are compared with each other (step S92). In other words, it is determined whether or not data of all of the divided blocks BK have been compared. If i<M·N, then the counter i is incremented by 1 (step S93), and control returns to step S85 in order to repeat steps S85 through S91. It i≧M·N, then it is judged that data of all of the divided blocks BK have been compared, and the sequence shown in FIG. 5 is brought to an end.

In this manner, the check image data generator 64 generates the first check image data D1 and the second check image data D2. The check image data generator 64 may perform various image processing processes, including an image scaling process, a color conversion process, etc., on the first check image data D1 and the second check image data D2, in order to display the first check image data D1 and the second check image data D2 at an appropriate size and an appropriate resolution on the display unit 28.

Display configurations for check images, which contain emphasized areas where compared image data differ from each other, will be described below with reference to FIGS. 7 through 9.

In response to a request from the operator to start a plate checking process, the display controller 44 displays the display screen 120 shown in FIG. 7 on the display unit 28.

The display screen 120 includes a tool bar 122, a first display area 124, a second display area 126, two vertically movable scroll bars 128, 130, and two horizontally movable scroll bars 132, 134.

The tool bar 122 extends horizontally at an upper portion of the display screen 120. The tool bar 122 has a number of icons, which will be described in detail later.

The first display area 124, which is disposed in the left portion of the display screen 120, displays a first check image 136 representing a portion of the first check image data D1. The first check image 136 includes a white background section 138, a character section 140 showing a certain number of characters (alphabetical characters in FIG. 7), and rectangular first colored areas 142, 144 that overlap with a portion of the character section 140. The first colored areas 142, 144, which are shown in hatching, are colored with a given color (first color), which differs from the displayed colors of the background section 138 and the character section 140. The displayed color of the first colored area 142 and the displayed color of a character, e.g. “b”, in the first colored area 142 have a contrast that can be visually perceived. Similarly, the displayed color of the first colored area 144 and the displayed color of a character, e.g. “o”, in the first colored area 144 have a contrast that can be visually perceived.

The second display area 126, which is disposed in the right portion of the display screen 120, displays a first image 146, which represents a portion of the first image data C1 (or a second image 147, which represents a portion of the second image data C2). The first image 146 includes a white background section 148 and a character section 150 showing a certain number of characters (alphabetical characters in FIG. 7).

The first display area 124 and the second display area 126 are of the same size. The first check image 136 and the first image 146 have identical displayed image areas.

The display controller 44 changes to the display screen 120a shown in FIG. 8 upon elapse of a prescribed period of time after the display controller 44 has started displaying the display screen 120 shown in FIG. 7. Since the display screen 120a is essentially the same as the display screen 120, the display screen 120a will not be described in detail below, except for differences thereof from the display screen 120.

The first display area 124 shown in FIG. 8 displays a second check image 152, which represents a portion of the second check image data D2. The second check image 152 includes a white background section 154, a character section 156 showing a number of characters, and rectangular second colored areas 158, 160 that overlap with a portion of the character section 156. The second colored areas 158, 160, which are shown in cross-hatching, are colored with a given color (second color), which is different from the displayed colors of the background section 154, the character section 156, and the first colored areas 142, 144 (see FIG. 7). The displayed color of the second colored area 158 and the displayed color of a character “d” in the second colored area 158 have a contrast that can be visually perceived. Similarly, the displayed color of the second colored area 160 and the displayed color of a character “a” in the second colored area 160 have a contrast that can be visually perceived.

Upon elapse of a prescribed time period after the display controller 44 has started displaying the display screen 120a shown in FIG. 8, the display controller 44 changes to the display of the display screen 120 shown in FIG. 7. The display controller 44 thus alternately displays the first check image 136 (see FIG. 7) and the second check image 152 (see FIG. 8) at given time intervals, within the same first display area 124.

Since the characters “b” and “d”, which represent a first area where the first image data C1 (the first image 136) and the second image data C2 (the second image 152) differ from each other, and the characters “a” and “o”, which represent a second area where the first image data C1 (the first image 136) and the second image data C2 (the second image 152) differ from each other, are displayed alternately in different colors (first and second colors), the areas where the first image data C1 and the second image data C2 differ from each other can be visually emphasized.

When the operator drags the scroll bar 128 with the mouse 34, the scroll bar 128 vertically slides the first check image 136 (or the second check image 152), which is displayed in the first display area 124 shown in FIG. 7.

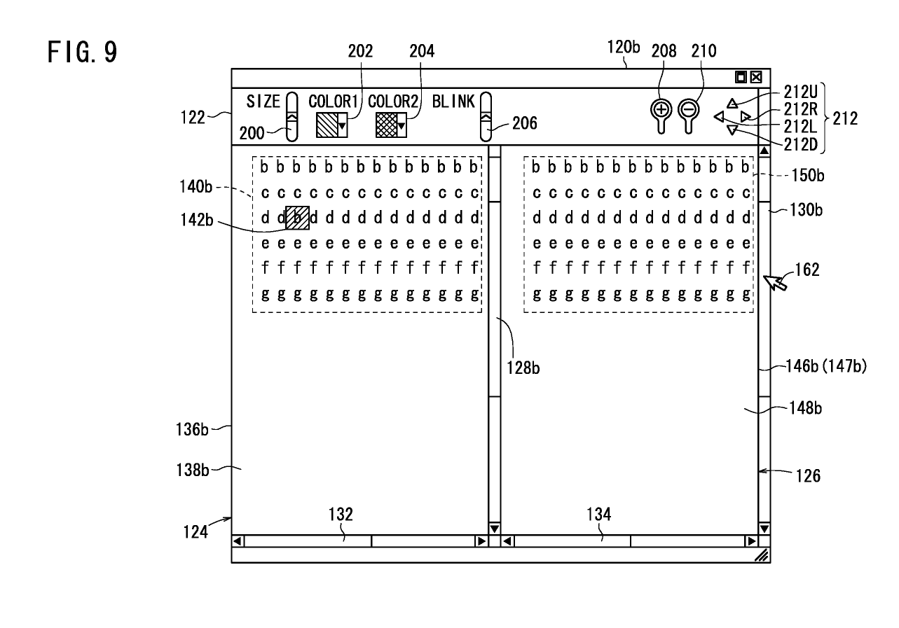

When the operator drags the scroll bar 128 with the mouse 34, while a pointer 162 (see FIG. 9) points at the scroll bar 128, the scroll bar 128 vertically slides the first check image 136. When the scroll bar 128b is positioned as shown in FIG. 9, a first check image 136b is displayed in a position, which is shifted upwardly from the first check image 136 shown in FIG. 7. More specifically, the first check image 136b includes a background section 138b, a character section 140, and a first colored area 142b, which are displayed in positions shifted upwardly from the background section 138, the character section 140, and the first colored areas 142, 144 of the first check image 136 (see FIG. 7). The first colored area 144b is not shown in FIG. 9, since the first colored area 144b is positioned outside (upwardly) of the first display area 124.

Similarly, when the operator drags the scroll bar 132 with the mouse 34, the scroll bar 132 horizontally slides the first check image 136 (or the second check image 152), which is displayed in the first display area 124 shown in FIG. 7.

According to the present embodiment, the first check image 136 displayed in the first display area 124 shown in FIG. 7, and the first image 146 (or the second image 147) displayed in the second display area 126 are simultaneously slid the same distance upon sliding of the scroll bars 128, 132. The first check image 136 and the first image 146 (or the second image 147) also are simultaneously slid upon sliding of the scroll bars 130, 134.

Since the images (the first check image 136 and the second check image 152) that are alternately displayed in the first display area 124 and the image (either one of the first image 146 and the second image 147) that is displayed in the second display area 126 are slid in a ganged relation to one another, the images can be observed in the same position at all times. Therefore, while confirming areas where the image data differ from each other in a screen area (the first display area 124), the operator can also confirm the correction process that takes place in another screen area (the second display area 126).

If the first image 146 is displayed in the second display area 126, a color patch of the first color may be displayed therewith, or may be displayed in an overlapping relation to the first image 146. Likewise, if the second image 147 is displayed in the second display area 126, a color patch of the second color may be displayed therewith, or may be displayed in an overlapping relation to the second image 147. In this manner, the operator can easily identify the type of image that is presently displayed in the second display area 126.

In FIG. 3, the operator determines whether or not all areas to be corrected have been corrected (step S9). If all areas to be corrected have not been corrected, then control returns to step S6, and steps S6 through S8 are repeated.

If all areas to be corrected, which were found in step S4, have been corrected, then control returns to step S3, and a proof print 24 is printed again. At this time, the proof press 22 prints a proof print 24 based on the newly edited data file stored in step S7. Subsequently, steps S3 through S9 are repeated until any areas requiring correction have been eliminated in the edited data. When the proofreading process is completed, the contents of the platemaking data file are finalized.

The operator then uploads the platemaking data file to the database server 16 (step S10). The controller 42 sends the latest edited data file stored in the memory 52 to the database server 16 via the I/F 36 and the LAN 18.

Finally, the operator performs a printing process (step S11). More specifically, the printing site 14 downloads the platemaking data file, which is stored in the database server 16. Thereafter, the image processing apparatus performs a desired image processing process on the platemaking data file, and the platesetter creates printing plates based on the processed platemaking data file. The offset press then prints a color image using the printing plates. Alternately, printing plates are not created, but rather, a digital printing press prints a color image directly based on the platemaking data file.

The full sequence from submission of manuscript data to the printing of a color image is now completed.

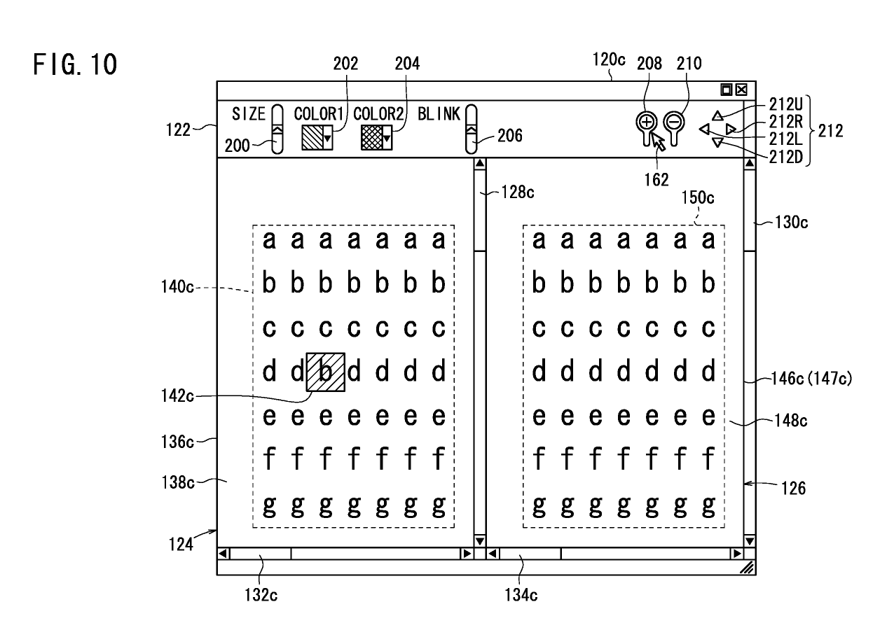

Additional functions of the plate check support display provided in the image processing apparatus 20 will be described below with reference to FIGS. 10 through 13. Images can be displayed in various configurations, using the icons on the tool bar 122 shown in FIGS. 7 through 9.

When the various display settings described below are changed, various image data are processed again and updated in order for the display controller 44 to display corresponding images on the display unit 28. For example, the check image data generator 64 may generate first check image data D1 or second check image data D2 again, according to the flowchart shown in FIG. 5. The display controller 44 may change a range for clipping the first image data C1, the second image data C2, the first check image data D1, or the second check image data D2. The RIP and scaling processor 40 may rescale the first image data C1, the second image data C2, the first check image data D1, or the second check image data D2.

The display adjuster 82 enters various display adjustment quantities to the main unit 26 according to actions made on the mouse 34, for thereby making various adjustments to the display configurations on the setting screen 100 (see FIG. 4). Details of such adjustments to the display configurations on the setting screen 100 will be described below.

The icons on the tool bar 122 include an adjustment bar 200, the indicated position of which can be vertically moved in order to finely adjust the sizes Sh, Sv (see FIG. 6) of the blocks BK. For example, the center position of the adjustment bar 200 corresponds to the sizes Sh, Sv entered in the text boxes 102, 104 (see FIG. 4). When the indicated position of the adjustment bar 200 is slid upwardly, the sizes Sh, Sv are increased, whereas when the indicated position of the adjustment bar 200 is slid downwardly, the sizes Sh, Sv are reduced.

The icons on the tool bar 122 also include a color selection menu 202 for selecting a color from a color pallet (not shown) in order to change the first color, which is the displayed color of the first colored areas 142, 144 (see FIG. 7). For example, the color entered in the color selection menu 106 (see FIG. 6) is preset in the color selection menu 202 as an initial color. Even during the plate checking process in step S8, the first color can be changed using the color selection menu 202.

The icons on the tool bar 122 also include a color selection menu 204 for selecting a color from a color pallet (not shown) in order to change the second color, which is the displayed color of the second colored areas 158, 160 (see FIG. 8). For example, the color entered in the color selection menu 108 (see FIG. 6) is preset in the color selection menu 204 as an initial color. Even during the plate checking process in step S8, the second color can be changed using the color selection menu 204.

The icons on the tool bar 122 further include an adjustment bar 206, which is capable of finely adjusting an alternate displaying cycle when the indicated position thereof is moved vertically. For example, the central position of the adjustment bar 206 corresponds to an alternate display time interval entered in the text box 110 (see FIG. 4). When the indicated position of the adjustment bar 206 is slid upwardly, the alternate display time interval is increased, whereas when the indicated position of the adjustment bar 206 is slid downwardly, the alternate display time interval is reduced.

The icons on the tool bar 122 further include an icon 208 for simultaneously displaying, at an enlarged scale, the first check image 136, which has been displayed in the first display area 124 shown in FIG. 7, and the first image 146 (or the second image 147), which has been displayed in the second display area 126 shown in FIG. 7, when the icon 208 is clicked by the mouse 34.

As shown in FIG. 10, when the operator clicks on the mouse 34 while the pointer 162 is pointing at the icon 208, a first check image 136c and a first image 146c (or a second image 147c) are displayed at an enlarged scale, at an image magnification ratio of 2. More specifically, the background section 138, the character section 140, and the first colored areas 142, 144, which make up components of the first check image 136 (see FIG. 7), are displayed respectively as a background section 138c, a character section 140c, and first colored areas 142c, 144c, which are enlarged at an image magnification ratio of 2. The first colored area 144c is not shown in FIG. 10, since the first colored area 144c is positioned outside of the first display area 124.

Similarly, the background section 148 and the character section 150, which make up components of the first image 146 (see FIG. 7), are displayed respectively as a background section 148c and a character section 150c, which are enlarged at an image magnification ratio of 2.

When the operator clicks on the mouse 34 while the pointer 162 is pointing at an icon 210, a first check image 136c and a first image 146c (or a second image 147c) are displayed at a reduced scale, at an image magnification ratio of 0.5, for example. In order to improve working efficiency, etc., a change (increment or decrement) in the display magnification ratio per mouse click may be determined in advance.

By changing the display magnification ratio of each image, the efficiency of the plate checking process can be increased. More specifically, when images including the first check image 136, etc., are displayed as a whole at a reduced magnification ratio, the operator can easily grasp the position of an area to be corrected. After having grasped the position of the area to be corrected, the operator can display the first colored area 142c of the first check image 136c, for thereby easily confirming the content of the correction.

When images displayed in the first display area 124 and the second display area 126 are successively displayed at an enlarged or reduced scale, the operator can confirm the content of the correction while checking the images against each other.

In FIG. 7, the icons on the tool bar 122 further include an icon 212 for vertically and horizontally shifting the first colored areas 142, 144 (or the second colored areas 158, 160), which are displayed in the first display area 124, when the icon 212 is clicked by the mouse 34. The icon 212 includes an upward icon 212U, a downward icon 212D, a rightward icon 212R, and a leftward icon 212L.

When the operator clicks on the mouse 34 while the pointer 162 is pointing at the icon 212, the icon 212 is capable of freely changing the positional relationship between the image data areas R1, R2 and the blocks BK.

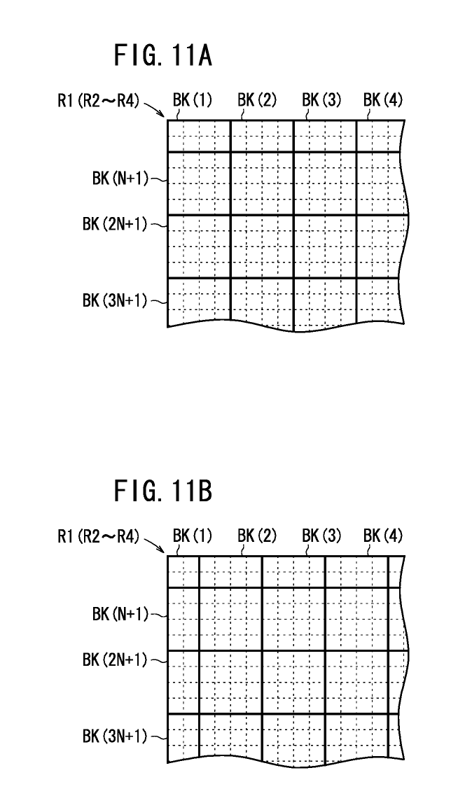

For example, it is assumed that the positional relationship shown in FIG. 6 represents an initial positional relationship. Each time that the icon 212U (or the icon 212D) is clicked, the block shift quantity determiner 72 shifts the position of each block BK upwardly (or downwardly) by a predetermined number of pixels. As a result, the position of each block BK is shifted upwardly (or downwardly) by two pixels, for example, as shown in FIG. 11A.

Further, each time that the icon 212R (or the icon 212L) is clicked, the block shift quantity determiner 72 shifts the position of each block BK rightwardly (or leftwardly) by a predetermined number of pixels. As a result, the position of each block BK is shifted rightwardly (or leftwardly) by two pixels, for example, as shown in FIG. 11B.

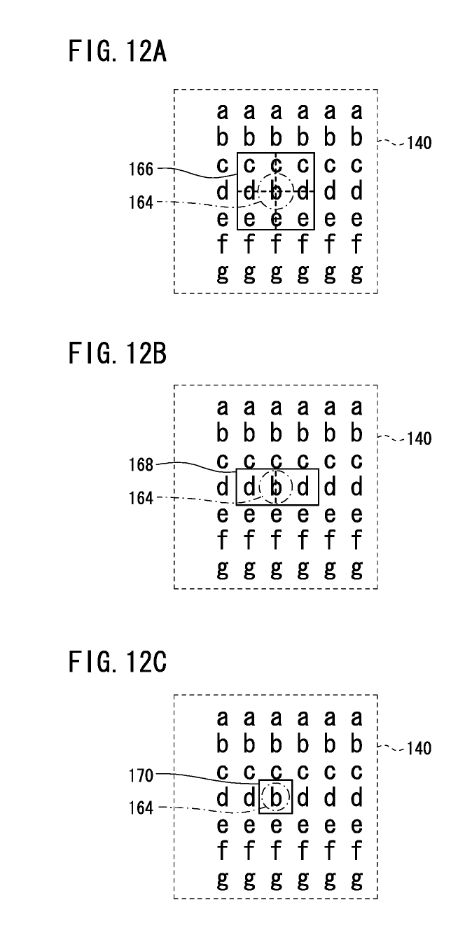

Advantages achieved by the above process of shifting each block BK will be described below. FIGS. 12A through 12C are partially enlarged views, showing a portion (around the first colored area 142) of the character section 140 of the first check image 136 shown in FIG. 7.

It is assumed that FIG. 12A shows an initial state of the character section 140. If the grid point of a block BK exists within the image area 164 represented by the character “b” where compared data disagree with each other, then the data, which are in disagreement, exist within the range of four blocks BK the vertexes of which are aligned with the grid point. Therefore, the first colored area 166 around the image area 164 colors over the four blocks BK. In this case, since each of third through fifth rows represented by the characters “c”, “d”, “e”) are colored, the operator is unable to grasp the position of the image area 164 at a glance, and it takes a certain amount of time to identify the content of the correction.

The operator then clicks the icon 212U (or the icon 212D) with the mouse 34 in order to shift the blocks BK upwardly (or downwardly) and achieve a positional relationship in which only two blocks BK overlap with the image area 164. At this time, a first colored area 168 around the image area 164 colors over two blocks BK (a single row). The operator can then recognize, at a glance, that the image area 164 exists within the fourth row (the row represented by the characters “d”), whereby the time required to identify the content of the correction can be reduced.

The operator then clicks the icon 212R (or the icon 212L) with the mouse 34 in order to shift the blocks BK rightwardly (or leftwardly) and achieve a positional relationship in which only one block BK overlaps with the image area 164. At this time, a first colored area 170 around the image area 164 colors over one block BK. The operator can then recognize, at a glance, that the image area 164 exists within the fourth row and the third column, whereby the time required to identify the content of the correction can be further reduced.

By thus finely adjusting the positions of the blocks BK with the icon 212, the efficiency of the plate checking process can be greatly increased. Fine adjustment of the positions of the blocks BK is particularly effective when applied to inspection of image data including the character section 140 where the character information is regularly arranged.

The block shift quantity determiner 72 may be arranged so as to automatically or manually acquire features of the character section 140, e.g., character intervals (intervals between adjacent characters and row intervals), or the direction (vertical or horizontal writing direction) in which the characters are arrayed, and to automatically determine a quantity by which the blocks BK are to be shifted.

The block size determiner 70 may be arranged so as to automatically or manually acquire features of the character section 140, e.g., size information (font size) of the characters, and to automatically determine the sizes Sh, Sv of the blocks BK. In this case, the block size determiner 70 may also refer to a resolution that is acquired from the resolution acquirer 56.

The comment information assignor 84 enters comment information, positional information, etc., to the main unit 26, according to prescribed actions on a tool box (not shown) and the mouse 34, for thereby assigning various items of comment information to the displayed images. More specifically, the comment information assignor 84 and the annotation processor 68 jointly perform an annotation function. The annotation function and advantages thereof will be described below.

It is assumed that the operator has recognized completion of correction of a first error (“b” instead of “d”) and a second error (“o” instead of “a”) by checking against each other the alternate display of images in the first display area 124, as described with reference to FIGS. 7 and 8, and the fixed display of the first image 146 in the second display area 126. However, in this example, the operator has forgotten correction of a third error (i.e., a blank instead of the character “f”).

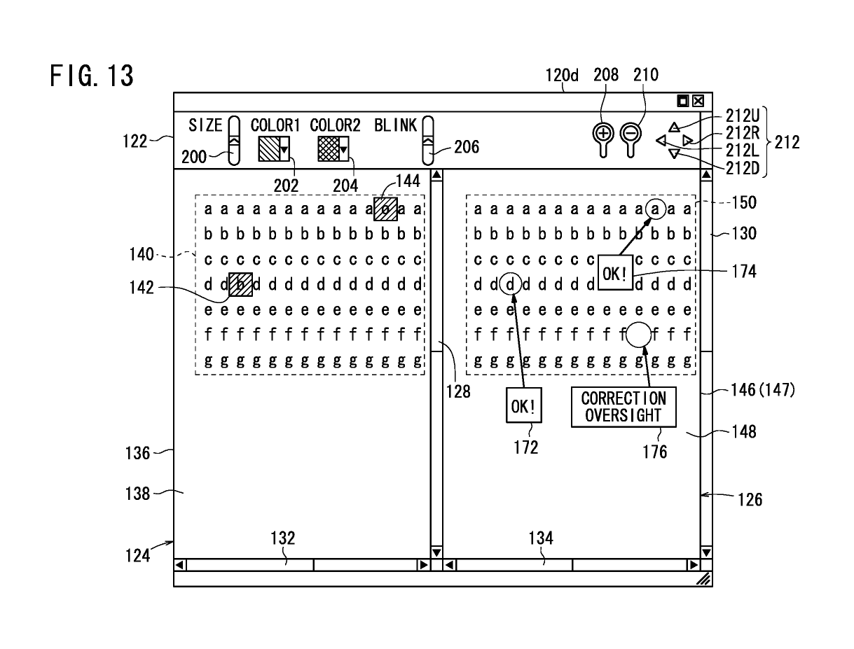

As shown in FIG. 13, the operator assigns, in a second display area 126 in the left portion of the display screen 120d, a comment field 172 (comment information) at a location corresponding to the first colored area 142, and a comment field 174 (comment information) at a location corresponding to the first colored area 144. The operator also assigns, in the second display area 126, a comment field 176 (comment information) at a location corresponding to the blank (an area not yet corrected).

In this manner, comment information, which indicates whether the contents of locations have been properly corrected, remains with respect to the corrected edited data, i.e., the second image data C2. When edited data, e.g., the first image data C1 including the comment information are displayed on the display unit 28 of the image processing apparatus 20 or another terminal device, the operator involved in the plate checking process, or another third party, can review and confirm the content of the comment information.

As described above, a resolution for the first image 146 or the second image 147 at a time of printing is acquired, and sizes Sh, Sv for blocks BK are determined depending on the acquired resolution. Image data R1, R2 are divided into a grid pattern of blocks BK having the determined sizes Sh, Sv. First image data C1 and second image data C2 are judged for agreement in each of the blocks BK, and a check image is displayed, which includes at least one of a first check image 136 and a second check image 152 produced by coloring a first image 146 and a second image 147, respectively, for each of the blocks BK in which the first image data C1 and the second image data C2 are judged as not being in agreement with each other. Consequently, appropriate sizes of actual images for determining whether data thereof are in agreement can be established, and areas within the character section 140 where the compared data differ from each other are appropriately emphasized along an array of characters. Even if edited data containing a large amount of regularly arranged character information are checked, areas where the compared data differ from each other can easily be identified, whereby the efficiency of the plate checking process can be increased.

When each of the image data areas R1, R2 is divided into a grid pattern of blocks BK, the blocks BK may be arranged at various different angles. The blocks BK may be arranged at an angle of 30 degrees, an angle of 45 degrees, or at any of other angle, rather than at an angle of 0 degrees as in the illustrated embodiment (see FIG. 6).

Although a certain preferred embodiment of the present invention has been shown and described in detail, it should be understood that various changes and modifications may be made to the embodiment without departing from the scope of the invention as set forth in the appended claims.

What is claimed is:

1. A plate check supporting method for displaying, in a predetermined display area, a check image showing emphasized areas where first image data and second image data generated in a platemaking process are not in agreement with each other, comprising:
a resolution acquiring step of acquiring a resolution for a first image represented by the first image data or a second image represented by the second image data when the first image or the second image is printed;
a block size determining step of determining sizes for blocks into which image data areas of the first image data and the second image data are divided, depending on the acquired resolution;
an area dividing step of dividing the image data areas into a grid pattern of blocks having the determined sizes;
an agreement judging step of judging the first image data and the second image data for agreement with respect to each of the blocks; and
a first display step of displaying a check image, which includes at least one of a first check image produced by coloring the first image and a second check image produced by coloring the second image, for each of the blocks in which the first image data and the second image data are judged as not being in agreement with each other.

2. The plate check supporting method according to claim 1, wherein in the first display step, the first check image, which is colored in a prescribed color, and the second check image, which is colored in a color different from the prescribed color, are displayed alternately at a prescribed time interval in a first display area within the predetermined display area.

3. The plate check supporting method according to claim 1, further comprising:
a second display step of displaying either one of the first image and the second image in a second display area, which does not overlap with the first display area, within the predetermined display area.

4. The plate check supporting method according to claim 3, further comprising:
a scroll display step of displaying the images displayed in the first display area and the second display area in a scrollable and ganged fashion, in response to an input action from the user.

5. The plate check supporting method according to claim 3, further comprising:
a scaled display step of displaying the images displayed in the first display area and the second display area at a scaled ratio in a ganged fashion, in response to an input action from the user.

6. The plate check supporting method according to claim 3, further comprising:
a comment information assigning step of assigning comment information to the image displayed in the second display area.

7. The plate check supporting method according to claim 1, further comprising:
a block position determining step of determining a positional relationship between the blocks, which are arranged cyclically, and the image data areas.

8. The plate check supporting method according to claim 1, wherein in the block size determining step, if the first image data or the second image data have image data representing characters, the sizes are determined for the blocks depending on size information of the characters and the resolution.

9. The plate check supporting method according to claim 7, wherein in the block position determining step, if the first image data or the second image data have image data representing characters, the positional relationship is determined depending on intervals between the characters and a direction of the characters.

10. The plate check supporting method according to claim 1, further comprising:
a check image data generating step of generating check image data depending on the check image, by performing a color conversion process for adding a prescribed value to or subtracting a prescribed value from all of the pixels in the blocks, for which the first image data and the second image data are judged as not being in agreement with each other.

11. The plate check supporting method according to claim 1, wherein in the block size determining step, the sizes are determined for the blocks so as to print the blocks at the same size irrespective of the resolution.

12. A plate check supporting apparatus for displaying, in a predetermined display area, a check image showing emphasized areas where first image data and second image data generated in a platemaking process are not in agreement with each other, comprising:
a resolution acquirer for acquiring a resolution for a first image represented by the first image data or a second image represented by the second image data when the first image or the second image is printed;
an area divider for determining sizes for blocks into which image data areas of the first image data and the second image data are divided, depending on the resolution acquired by the resolution acquirer, and dividing the image data areas into a grid pattern of blocks having the determined sizes;
an image agreement determiner for judging the first image data and the second image data for agreement with respect to each of the blocks produced by the area divider; and
a display unit for displaying a check image, which includes at least one of a first check image produced by coloring the first image and a second check image produced by coloring the second image, for each of the blocks in which the first image data and the second image data are judged as not being in agreement with each other by the image agreement determiner.

13. A recording medium storing therein a program for displaying, in a predetermined display area, a check image showing emphasized areas where first image data and second image data generated in a platemaking process are not in agreement with each other, the program enabling a computer to function as:
a resolution acquirer for acquiring a resolution for a first image represented by the first image data or a second image represented by the second image data when the first image or the second image is printed;
an area divider for determining sizes for blocks into which image data areas of the first image data and the second image data are divided, depending on the resolution acquired by the resolution acquirer, and dividing the image data areas into a grid pattern of blocks having the determined sizes;
an image agreement determiner for judging the first image data and the second image data for agreement with respect to each of the blocks produced by the area divider; and
a check image data generator for generating check image data depending on a check image, which includes at least one of a first check image produced by coloring the first image and a second check image produced by coloring the second image, for each of the blocks in which the first image data and the second image data are judged as not being in agreement with each other by the image agreement determiner.
